(19) United States
(12) Patent Application Publication
(10) Pub. No.: US 2025/0350471 A1
(43) Pub. Date: Nov. 13, 2025

(54) Coefficient Rejection Sampling and Shuffling for Signature Generator

(71) Applicant: Microsoft Technology Licensing, LLC, Redmond, WA (US)

(72) Inventors: Mojtaba BISHEH NIASAR, Dover, NH (US); Bharat S. PILLILLI, El Dorado Hills, CA (US); Michael Jeffrey NORRIS, Folsom, CA (US)

(21) Appl. No.: 18/657,460

(22) Filed: May 7, 2024

(51) Int. Cl. H04L 9/32; G06F 7/58

(52) U.S. Cl. CPC H04L 9/3247; G06F 7/588

(57) ABSTRACT

A method provides lattice based cryptographic system pseudorandom polynomial coefficients by repetitively receiving sets of n coefficient samples of a random bit string, where n is at least four, repetitively rejection sampling n coefficient samples in parallel to identify valid coefficients, performing a random shuffle of the valid coefficients, and storing sets of n shuffled coefficients in a memory each address configured to hold n coefficients.

### BACKGROUND

The advent of quantum computers poses a serious challenge to the security of the existing public-key cryptosystems, as they can potentially be broken based on Shor's algorithm. Lattice-based cryptosystems are among the most promising post quantum computing (PQC) algorithms that are believed to be hard to crack for both classical and quantum computers.

A SampleInBall algorithm is used to pseudorandomly sample a polynomial c∈Rq based on the Fisher-Yates shuffle that has coefficients in {−1, 0, 1} and Hamming weight τ. Rq is the ring of single-variable polynomials over Zq modulo X\hat{ }256+1, also denoted by Zq[X\hat{ }256]/(X+1). Zq is the ring of integers modulo q, also denoted by Z/qZ.

The performance of the entire PQC signature algorithm is contingent upon the polynomial c from the SampleInBall algorithm, as all subsequent operations after SampleInBall algorithm are reliant on the polynomial. Therefore, the SampleInBall algorithm execution speed is a critical factor in determining the overall speed of the algorithm.

### SUMMARY

A method provides lattice based cryptographic system pseudorandom polynomial coefficients by repetitively receiving sets of n coefficient samples of a random bit string, where n is at least four, repetitively rejection sampling n coefficient samples in parallel to identify valid coefficients, performing a random shuffle of the valid coefficients, and storing sets of n shuffled coefficients in a memory each address configured to hold n coefficients.

### BRIEF DESCRIPTION OF THE DRAWINGS

FIG. 1 is a high-level block flow diagram of an improved lattice-based cryptographic system according to an example embodiment.

FIG. 2 is a block representation of a polynomial format in memory that is compatible with a number theoretic transform (NTT) cryptographic system according to an example embodiment.

FIG. 3 is a graph indicating a probability of failure of rejection sampling per sample according to an example embodiment.

FIG. 4 is a block diagram illustrating a sampling portion of a rejection sampling unit according to an example embodiment.

FIG. 5 is a block diagram illustrating a shuffling portion of a rejection sampling unit according to an example embodiment.

FIG. 6 is a flowchart of a method 600 of identifying and shuffling valid samples for use in an NTT system according to an example embodiment.

FIG. 7 is flowchart of a method of performing a random shuffle of valid samples according to an example embodiment.

FIG. 8 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Lattice-based cryptosystems are among the most promising PQC algorithms that are believed to be hard for both classical and quantum computers. A SampleInBall algorithm is used to pseudorandomly sample a polynomial c∈Rq based on a Fisher-Yates shuffle that has coefficients in {−1, 0, 1} and Hamming weight τ.

The performance of the entire PQC signature algorithm is contingent upon the polynomial c from the SampleInBall algorithm, as all subsequent operations after SampleInBall algorithm are reliant on it. Therefore, the function's execution speed is a critical factor in determining the overall speed of the algorithm.

An improved system has an efficient architecture that uses a memory-based design to achieve a balance between generating a random bit string for rejection checking and shuffling by the SampleInBall algorithm. The architecture lowers hardware resources needed by rejection sampling samples in parallel and provides an output in a specific pattern that is useful for a high-performance lattice-based cryptographic system.

A Dilithium signature scheme is an advanced cryptographic protocol based on a Fiat-Shamir heuristic, which is a non-interactive version of interactive proof systems. The Fiat-Shamir transformation converts an interactive identification scheme into a non-interactive signature scheme. In the case of Dilithium, the transformation is applied to a lattice-based identification scheme, resulting in a digital signature that is secure against quantum computer attacks.

During the signing operation, the Fiat-Shamir heuristic necessitates a commitment and challenge phase. The commitment phase involves a prover (signer) sending a commitment to a verifier (entity verifying the signature), which is a hash of a public key and a message being signed, along with some random values. The challenge phase then follows, where a verifier sends a challenge back to the prover.

In Dilithium, the SampleInBall algorithm is used in generating this challenge. The SampleInBall algorithm samples a polynomial, c, at random from a ball, which is then hashed using a random number generator such as Keccak. Keccak, a SHA-3 finalist, is renowned for its security and efficiency. It generates a stream of random bits that are used to form the challenge in the Fiat-Shamir transformation. This challenge binds the commitment to the final signature, ensuring that the signature is tied to a specific message and cannot be reused.

SampleInBall is a procedure that uses the SHAKE256 of a seed ρ to produce a random element of Bτ. The procedure uses the Fisher-Yates shuffle method to randomize locations of entries or coefficients of c. The signs of the nonzero entries of c are determined by the first 8 bytes of H(ρ), and the following bytes of H(ρ) are used to determine the locations of those nonzero entries.

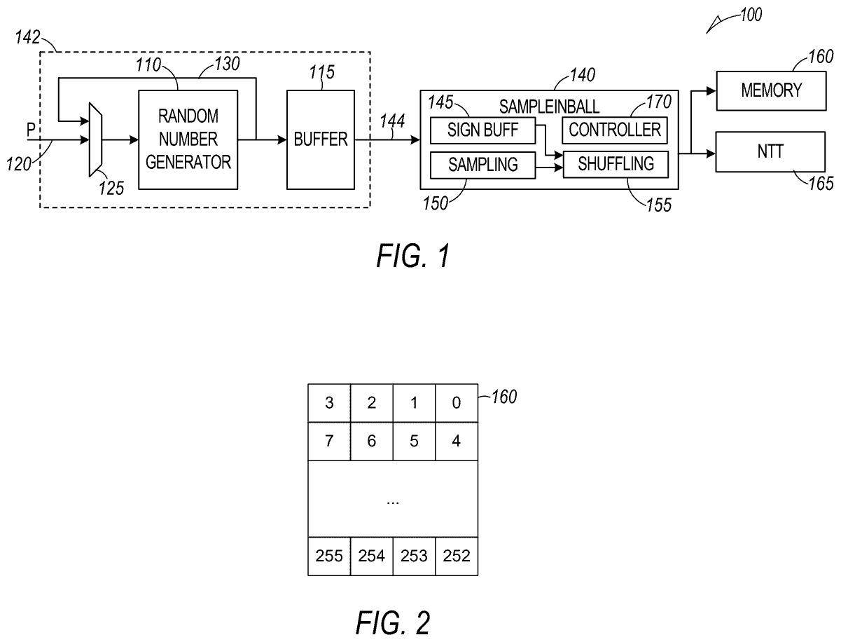

FIG. 1 is a high-level block flow diagram of an improved lattice-based cryptographic system 100. System 100 includes a random number generator 110. A Keccak hash function may be used as random number generator 110. The random number generator 110 produces a random bit string that is stored in a buffer 115. Buffer 115 may be a parallel in, serial out (PISO) buffer in one example.

A seed, ρ 120, is provided via a multiplexer 125 to the random number generator 110. A new seed is provided for each polynomial. The buffer 115 in one example is not large enough to buffer the number of bits needed for system 100 to process the coefficients of an entire polynomial, so a loop path 130 is provided back to the multiplexer 125 to prompt the random generator 110 to provide a next number of bits of the bitstream to butter 115 for a current polynomial until all the coefficients of the current polynomial are processed. In one example, the random number generator 110, buffer 115, multiplexer 125 and loop path 130 form a random number generator unit 142.

The buffer 115, in one example, provides n samples, where n is an integer, to a cascaded SampleInBall unit 140 via sample line 144. SampleInBall unit 140 includes a sign buffer 145 and a sampling circuit 150. In one example, n sampling circuits 150 (where n=four) operate in parallel to identify valid samples. A shuffling unit 155 is used to randomize positions of the valid samples in a memory 160 that stores n valid samples at each address. Once a sufficient number of samples are stored, a number theoretic transform (NTT) unit 165 accesses the memory 160.

The system 100 reduces the cost of memory 160 access from the random number generator 110 to SampleInBall unit 140, and from SampleInBall unit 140 to NTT unit 165. System 100 writes a specific pattern of coefficients into memory 160 for the NTT unit 165 that prevents excessive buffering or interference between them. The system 100 also lowers the rejection rate and speeds up SampleInBall unit 140 operations while maintaining a small and efficient circuit footprint. The system 100 can be optimized and mapped to field programmable gate arrays (FPGA) and application specific integrated circuit (ASIC) platforms to develop highly efficient PQC lattice-based cryptographic systems.

In one example, random number generator 110 is a Keccak random number generator in a SHAKE-256 configuration for SampleInBall unit 140 operations. Random number generator 110 will take the input seed ρ 120 with 256-bits and generate 1088-bit output bit string after each round.

The first τ bits (τ=60 in the case of ML-DSA-87 (Module Lattice Digital Signature Algorithm-87)) in the first 8 bytes of this random bit string are interpreted as t random sign bits si∈{0, 1}, I=0, . . . , τ−1. The rest of the bits, 64−t bits are discarded.

The remaining random bits are used for sampling via SampleInBall unit 140. 8-bits are used for each sample. A first round of random number generator 110 output provides (1088−64)/8=128 samples. The number of valid samples needed by NTT unit 165 is 60. Because the sampling operation is non-deterministic, if more samples are required, the random number generator 110 will run again and produce 1088/8=136 additional samples. Hence, there are two paths for random number generator input, ρ 120 and loop path 130 provided selectively via multiplexer 125. While the input seed ρ 120 can be set by a controller 170 in SampleInBall unit 140 for each new polynomial c, the loop path 130 is used to rerun a, for example, Keccak hash function for completing one polynomial before proceeding to process a next polynomial.

SampleInBall unit 140 includes n parallel rejection samplers, where n is less than the number of samples stored in buffer 115 and cannot take all samples in parallel since it makes hardware architecture too costly and complex. The buffer 115 is used to store the random number generator 110 output and feed SampleInBall unit 140 sequentially.

The SampleInBall unit 140 takes data from the output stored in buffer 115. A number of cycles for the SampleInBall unit 140 to operate on all the samples for one polynomial is variable due to the non-deterministic pattern of sampling. But this operation can only be finished with 60 valid samples.

The SampleInBall unit 140 works in parallel with the random number generator 110. The latency for random number generation is absorbed within the latency for a concurrently running SampleInBall core.

FIG. 2 is a block representation of a polynomial format in memory 160 that is compatible with the NTT unit 165. In one example, the NTT unit 165 operates on n coefficients, such as n=four coefficients per cycle, the same as the number of parallel rejection samplers. This implies that the output of memory 160 contains four samples that are provided for each address. In further examples, the number of parallel rejection samplers and coefficients can be different.

SampleInBall unit 140 performs the following sampling and randomizing algorithm to identify and store valid samples in randomized storage locations:
(1) Initialize c=c0 c1 . . . c255=0 0 . . . 0
(2) for i:=256−τ to 255
(3) j←{0, 1, . . . , i}
(4) s←{0, 1}
(5) ci:=cj
(6) cj:=(−1)^{s}
(7) return c

The SampleInBall algorithm first initializes memory 160 with zeros at (1) and then performs a loopCheck initialized with an iteration over i at line (2). The loopCheck checks the validity of input samples respect to parameter i at line (3), and stores the sign s at line (4).

Lines (5) and (6) shuffle the stored polynomial c with respect to parameters i, j, and s.

For ML-DSA-87 with τ=60, 60 valid samples are required.

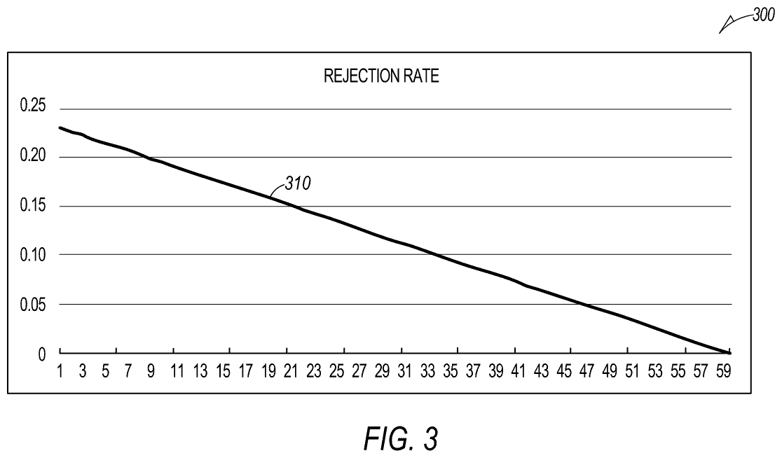

The validity check on the input sample depends on an iteration number i while a sample greater than i will be rejected. FIG. 3 is a graph 300 indicating a probability of rejection sampling failure per sample, line 310, for each round, 1-60. Line 310 shows that the probability of rejection decreases as more valid samples have been identified.

To reduce the failure probability and avoid any wait cycle in shuffling coefficients, in one example n=4 samples are fed into SampleInBall unit 140 while only one sample will be passed to shuffling unit 155. This example reduces the probability of failure to:

$$probability of having 4 rejected inputs = {( {rejection}_{rate} )}^{4}$$

In the worse case scenario (the first iteration with i=196), the failure probability is:

$${( 0.23046 )}^{4} = 0.00282$$

The unused coefficients will be processed in the next cycle when i increments. Processing the unused coefficients in the next cycle requires performing the rejection sampling again with i incremented.

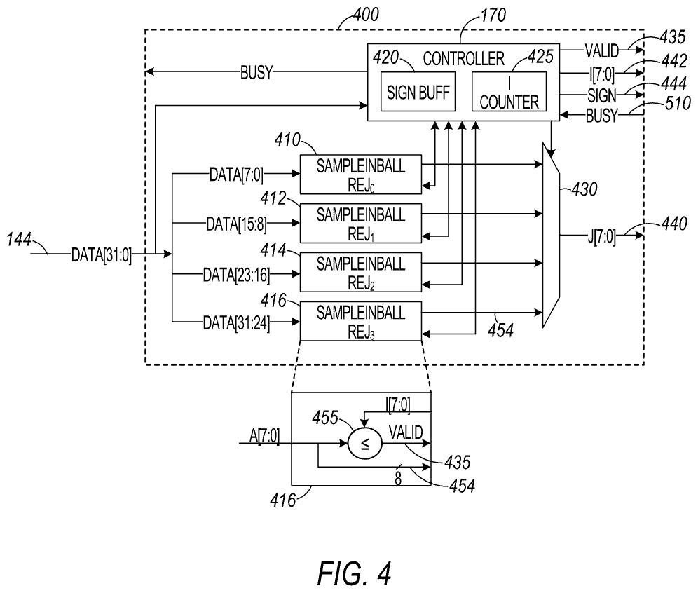

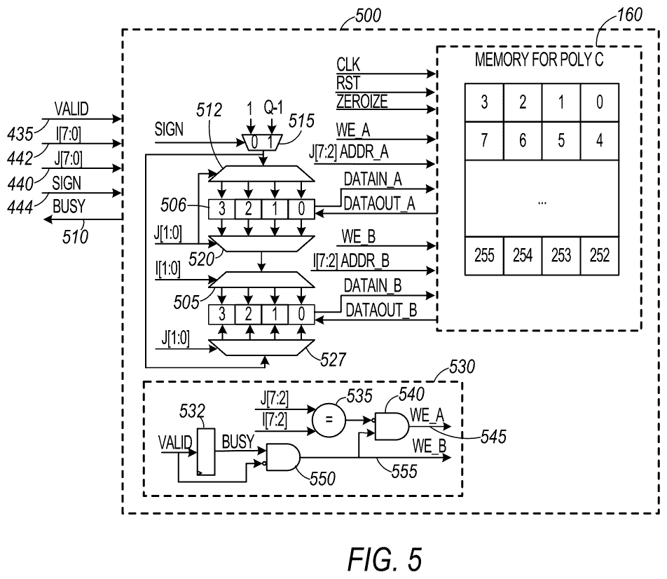

FIG. 4 is a block diagram illustrating a sampling portion 400 of the SampleInBall unit 140. FIG. 5 is a block diagram illustrating a shuffling portion 500 of the SampleInBall unit 140. Sampling portion 400 receives n samples via sample line 144 that are provided to n=4 rejection circuits 410, 412, 414, and 416. Sampling portion 400 performs cycles to implement a sampling portion of the sampling and randomizing algorithm. A first 2 cycles are used to store sign bits into a sign buffer 420 accessible to controller 170. After that, each 32 bits of input will be divided into 4 samples. Each sample is compared to i obtained from i counter 425 and the first valid sample is passed into the shuffling portion 500 via a multiplexer 430 under control of the controller 170.

Controller 170 uses the counter 425 to manage the i value. The counter 425 starts at 196 (for ML-DSA-87) and goes up after a valid coefficient is found.

When a valid coefficient is found, valid flag 435 will be set and the chosen sample (known by j) on line 440, i on line 442, and s on line 444 will be transferred to shuffling portion 500 via multiplexer 430. Following such transfer, the counter 425 value of i is incremented, and the remaining samples will be compared to the new i value.

An example rejection circuit 416 is shown in further detail and includes a comparator 455 that determines if the sample a[7:0] is less than or equal to i[7:0]. If yes, the valid flag 435 is raised and the sample is provided on line 454 to the multiplexer 430. Each of the rejection circuits 410, 412, 414, 416 perform the same operation in parallel and the first rejection circuit having a valid sample has its sample provided via multiplexer 430 under control of controller 170 provided as output on line 440.

In shuffle portion 500 of SampleInBall unit 140, a polynomial c is stored in memory 160 that has four coefficients for each address. This pattern is used for the NTT unit 165 operation that works on the output of SampleInBall unit 140. As indicated above, memory 160 is initialized to zeros. The memory 160 has two ports, a and b, that can read or write data as illustrated by lines respectively labeled with “_a” and “_b.”

Each input sample is processed using two cycles. In the first cycle, the memory 160 reads the two addresses that have i and j, storing them respectively at registers 505 and 506 and in the second cycle, the memory saves the new coefficients. A busy flag 510 is raised while such cycles are being performed.

The read data from address j will be updated via a demultiplexer 512 by 1 or q−1 at 515 based on the s value, while the original value of j is transferred to address i using a multiplexer 520 and demultiplexer 525.

When i and j have the same address, both ports of memory 160 would try to write to the same location in the second cycle. To avoid such duplicate write attempts, port a is disabled for address j and j will be changed in the same register 505 that has i (port b) and will be saved into memory. The change is performed via a demultiplexer 527 that receives j and the output from 515. Otherwise, both ports are used in the second cycle to store the new values of i and j in registers 505 and 506 respectively, resulting in shuffling of the samples of memory 160.

Circuitry 530 is used to disable port a. Circuitry 530 receives the valid flag at 532 causing the busy flag 510 to be raised. A compare 535 is then performed to determine if i and j are equal. If equal, a NAND gate 540 is used to prevent a write enable signal, we_a at 545 from allowing a write on port a. A NAND gate 550 receives the busy signal and valid signal to enable writing on port b via we_b at 555.

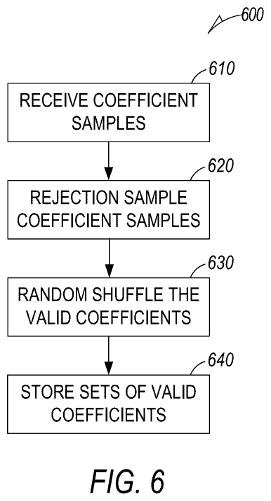

FIG. 6 is a flowchart of method 600 of identifying and shuffling valid samples to provide pseudorandom polynomial coefficients for use in an NTT system. Method 600 begins at operation 610 by repetitively receiving sets of n coefficient samples of a random bit string, where n is at least four. The random bit string may be provided by a Keccak random number generator in one example. The random bit string may be stored in a parallel in, serial out (PISO) buffer.

Operation 620 performs repetitive rejection sampling of n coefficient samples in parallel to identify valid coefficients. Rejection sampling performs an iteration over i and compares a corresponding coefficient to i until a first valid coefficient is found upon which the first valid coefficient is provided for performing a random shuffle.

The random shuffle of the valid coefficients is performed at operation 630 and operation 640 stories sets of n shuffled coefficients in a memory, where each memory each address is configured to hold n coefficients.

The random shuffle in one example includes a Fisher-Yates shuffle. Sign bits of the samples are stored in a sign buffer for performing the random shuffle.

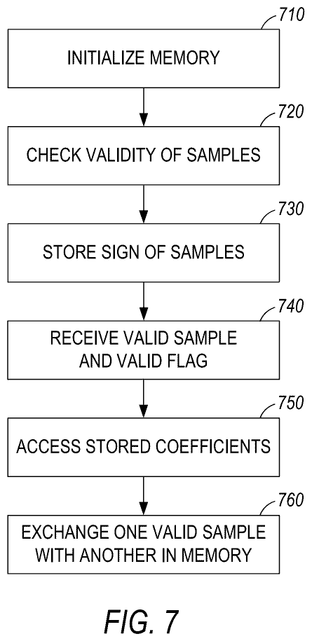

FIG. 7 is a flowchart of a method 700 of performing the random shuffle. Method 700 begins at operation 710 by initializing the memory. The validity of the four coefficient samples is checked at operation 720. A sign s is stored at operation 730 for each coefficient sample. One valid sample, j (where j←{0, 1, . . . , i}), s, i, and a valid flag is received at operation 740 and coefficients stored in the memory at i and j are accessed at operation 750. The one valid sample is exchanged at operation 760 with another sample stored in the memory.

In one example, the memory has two ports and is capable of writing two samples in parallel. If two samples to be written are to be written to a same address of the memory, one port is disabled, and the two samples are written at a same time via the port that is not disabled. In response to at least one sample remaining in parallel following a valid sample being found, i is incremented and rejection sampling is performed on the at least one sample remaining.

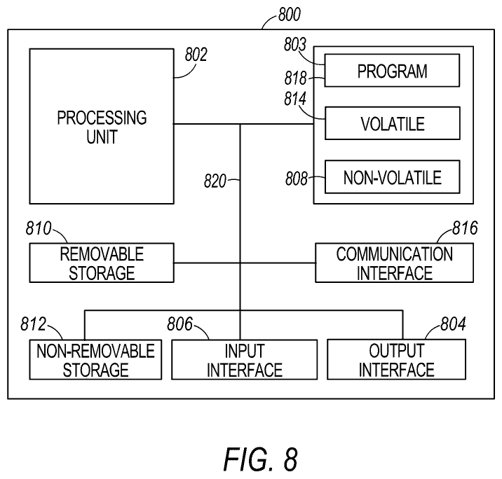

FIG. 8 is a block schematic diagram of a computer system 800 for implementing at least controller 170 and other components and units of the system and for performing methods and algorithms according to example embodiments. All components need not be used in various embodiments.

One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, smart storage device (SSD), or other computing device including the same or similar elements as illustrated and described with regard to FIG. 8. Devices, such as smartphones, tablets, and smartwatches, are generally collectively referred to as mobile devices or user equipment.

Although the various data storage elements are illustrated as part of the computer 800, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 803 may include volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input interface 806, output interface 804, and a communication interface 816. Output interface 804 may include a display device, such as a touchscreen, that also may serve as an input device. The input interface 806 may include one or more of a touchscreen, touchpad, mouse, keyboard, camera, one or more device-specific buttons, one or more sensors integrated within or coupled via wired or wireless data connections to the computer 800, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 800 are connected with a system bus 820.

Computer-readable instructions stored on a computer-readable medium are executable by the processing unit 802 of the computer 800, such as a program 818. The program 818 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 818 along with the workspace manager 822 may be used to cause processing unit 802 to perform one or more methods or algorithms described herein.

### EXAMPLES

A method provides lattice based cryptographic system pseudorandom polynomial coefficients by repetitively receiving sets of n coefficient samples of a random bit string, where n is at least four, repetitively rejection sampling n coefficient samples in parallel to identify valid coefficients, performing a random shuffle of the valid coefficients, and storing sets of n shuffled coefficients in a memory each address configured to hold n coefficients.
2. The method of example 1 wherein the random shuffle includes a Fisher-Yates shuffle.
3. The method of any of examples 1-2 and further including storing sign bits of the samples in a sign buffer for performing the random shuffle.
4. The method of any of examples 1-3 wherein the random bit string is provided by a Keccak random number generator.
5. The method of any of examples 1-4 wherein the random bit string is stored in a parallel in, serial out (PISO) buffer prior to receiving sets of n coefficient samples.
6. The method of any of examples 1-5 wherein performing the random shuffle includes initializing the memory, checking the validity of the four coefficient samples, and storing a sign s for each coefficient sample.
7. The method of example 6 wherein performing the random shuffle includes receiving one valid sample, j (where j←{0, 1, . . . , i}), s, i, and a valid flag, reading coefficients stored in the memory at i and j, and exchanging the one valid sample with another sample stored in the memory.
8. The method of example 7 wherein the memory has two ports and is capable of writing two samples in parallel.
9. The method of example 8 wherein if two samples to be written are to be written to a same address of the memory, one port is disabled, and the two samples are written at a same time via the port that is not disabled.
10. The method of any of examples 1-9 wherein rejection sampling performs an iteration over i and compares a corresponding coefficient to i until a first valid coefficient is found upon which the first valid coefficient is provided for performing the random shuffle.
11. The method of example 10 wherein in response to at least one sample remaining in parallel following a valid sample being found, incrementing i and performing rejection sampling on the at least one sample remaining.
12. A cryptographic sampling rejection and shuffling system includes a sampling unit. The sampling unit includes n parallel rejection circuits coupled to receive n samples from a buffer containing a random bit string, where n is an integer having a value of at least 4, a controller that includes a sign buffer and a counter coupled to control the rejection circuits to compare the samples to a count value i and raise a valid flag in response to a valid sample being found, a sampling multiplexer coupled to receive a valid sample from one of the rejection circuits. The system includes a shuffling unit coupled to receive the valid sample in response to the valid flag and to receive the counter value and sign corresponding to the valid sample. The shuffling unit includes a memory having two ports to access memory addresses, each address configured to hold n samples, two registers for buffering samples from two different addresses, and multiplexers and demultiplexers coupled to modify samples in the registers for writing back to the memory to perform a random shuffle of valid samples in the memory.
13. The system of example 12 wherein n=4.
14. The system of any of examples 12-13 wherein shuffling unit is configured to perform a Fisher-Yates shuffle.
15. The system of any of examples 12-14 and further including a Keccak random number generator coupled to the buffer to provide the random bit string, wherein the buffer comprises a parallel in, serial out (PISO) buffer.
16. The system of any of examples 12-15 wherein the controller is configured to initialize the memory, store a sign s for each coefficient sample, control the sampling multiplexer to provide the valid sample, and control the registers, multiplexers, and demultiplexers of the shuffling unit.
17. The system of example 16 wherein the controller is configured to disable one of the memory ports in response to two samples to be written to a same address of the memory, such that the two samples are written at a same time via the port that is not disabled.
18. The system of any of examples 16-17 wherein the controller is configured cause the sampling unit to, in response at least one sample remaining in parallel following a valid sample being found, increment i and perform rejection sampling on the at least one sample remaining.
19. A cryptographic sampling rejection and shuffling system includes a sampling unit that includes n parallel rejection circuits coupled to receive n samples from a buffer containing a random bit string, where n is an integer having a value of at least 4 to compare the samples to a count value i. A memory has two ports to access memory addresses, where each address is configured to hold n samples. A shuffling unit is coupled to receive one valid sample at a time and perform a Fisher-Yates shuffle of samples stored in the memory.
20. The system of example 19 wherein the system is configured to perform a SampleInBall algorithm to provide coefficients for signature generation by a number theoretic transform (NTT) system.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method for providing lattice based cryptographic system pseudorandom polynomial coefficients the method comprising:
repetitively receiving sets of n coefficient samples of a random bit string, where n is at least four;
repetitively rejection sampling n coefficient samples in parallel to identify valid coefficients;
performing a random shuffle of the valid coefficients; and
storing sets of n shuffled coefficients in a memory each address configured to hold n coefficients.

2. The method of claim 1 wherein the random shuffle comprises a Fisher-Yates shuffle.

3. The method of claim 1 and further comprising storing sign bits of the samples in a sign buffer for performing the random shuffle.

4. The method of claim 1 wherein the random bit string is provided by a Keccak random number generator.

5. The method of claim 1 wherein the random bit string is stored in a parallel in, serial out (PISO) buffer prior to receiving sets of n coefficient samples.

6. The method of claim 1 wherein performing the random shuffle comprises:
initializing the memory;
checking the validity of the four coefficient samples; and
storing a sign s for each coefficient sample.

7. The method of claim 6 wherein performing the random shuffle comprises:
receiving one valid sample, j (where j←{0, 1, . . . , i}), s, i, and a valid flag;
reading coefficients stored in the memory at i and j; and
exchanging the one valid sample with another sample stored in the memory.

8. The method of claim 7 wherein the memory has two ports and is capable of writing two samples in parallel.

9. The method of claim 8 wherein if two samples to be written are to be written to a same address of the memory, one port is disabled and the two samples are written at a same time via the port that is not disabled.

10. The method of claim 1 wherein rejection sampling performs an iteration over i and compares a corresponding coefficient to i until a first valid coefficient is found upon which the first valid coefficient is provided for performing the random shuffle.

11. The method of claim 10 wherein in response to at least one sample remaining in parallel following a valid sample being found, incrementing i and performing rejection sampling on the at least one sample remaining.

12. A cryptographic sampling rejection and shuffling system comprises:
a sampling unit comprising:
n parallel rejection circuits coupled to receive n samples from a buffer containing a random bit string, where n is an integer having a value of at least 4;
a controller that includes a sign buffer and a counter coupled to control the rejection circuits to compare the samples to a count value i and raise a valid flag in response to a valid sample being found;
a sampling multiplexer coupled to receive a valid sample from one of the rejection circuits; and
a shuffling unit coupled to receive the valid sample in response to the valid flag and to receive the counter value and sign corresponding to the valid sample, the shuffling unit comprising:
a memory having two ports to access memory addresses, each address configured to hold n samples;
two registers for buffering samples from two different addresses; and
multiplexers and demultiplexers coupled to modify samples in the registers for writing back to the memory to perform a random shuffle of valid samples in the memory.

13. The system of claim 12 wherein n=4.

14. The system of claim 12 wherein shuffling unit is configured to perform a Fisher-Yates shuffle.

15. The system of claim 12 and further comprising a Keccak random number generator coupled to the buffer to provide the random bit string, wherein the buffer comprises a parallel in, serial out (PISO) buffer.

16. The system of claim 12 wherein the controller is configured to:
initialize the memory;
store a sign s for each coefficient sample;
control the sampling multiplexer to provide the valid sample; and
control the registers, multiplexers, and demultiplexers of the shuffling unit.

17. The system of claim 16 wherein the controller is configured to disable one of the memory ports in response to two samples to be written to a same address of the memory, such that the two samples are written at a same time via the port that is not disabled.

18. The system of claim 16 wherein the controller is configured cause the sampling unit to, in response at least one sample remaining in parallel following a valid sample being found, increment i and perform rejection sampling on the at least one sample remaining.

19. A cryptographic sampling rejection and shuffling system comprises:
a sampling unit comprising:
n parallel rejection circuits coupled to receive n samples from a buffer containing a random bit string, where n is an integer having a value of at least 4 to compare the samples to a count value i;
a memory having two ports to access memory addresses, each address configured to hold n samples; and
a shuffling unit coupled to receive one valid sample at a time and perform a Fisher-Yates shuffle of samples stored in the memory.

20. The system of claim 19 wherein the system is configured to perform a SampleInBall algorithm to provide coefficients for signature generation by a number theoretic transform (NTT) system.
